(19) United States
(12) Patent Application Publication
(10) Pub. No.: US 2016/0189087 A1
(43) Pub. Date: Jun. 30, 2016

(54) Cargo Apportionment Techniques

(71) Applicant: Hand Held Products, Inc,., Fort Mill, SC (US)

(72) Inventors: Bruce McKay Morton, Lake Stevens, WA (US); Ryan McMahan, Cedar Rapids, IA (US)

(21) Appl. No.: 14/614,796

(22) Filed: Feb. 5, 2015

Related U.S. Application Data
(60) Provisional application No. 62/098,188, filed on Dec. 30, 2014.

(51) Int. Cl. G06Q 10/08

(52) U.S. Cl. CPC G06Q 10/083

(57) ABSTRACT

Information is presented relating to positions within delivery vehicles designated for transporting particular items of a multi-parcel cargo. Cargo-related information is evaluated in relation to characteristic(s) of each parcel. The information for transport-positioning the cargo item is computed based on the evaluation. Entry of the cargo item is registered upon loading and an identifier is visibly directed to its transport position. Geo-positioning of the vehicle is tracked over its route. Destination approach/arrival is detected based on the tracking and the visible identifier is redirected to the item's position. The identifier may be projected controllably by a pointer/projector, including delivery related information (e.g., related to delivery, warnings, etc.). Visibility may be enhanced using reflective surfaces.

### CROSS-REFERENCE TO RELATED APPLICATION

The present application claims the benefit of U.S. Patent Application No. 62/098,188 for Cargo Apportionment Techniques filed Dec. 30, 2014. The foregoing patent application is hereby incorporated by reference in its entirety.

### TECHNOLOGY

The present disclosure relates generally to logistics. An example embodiment of the present invention relates to apportioning cargo in a delivery vehicle.

### BACKGROUND

Generally speaking, the delivery of cargo to final destinations comprises a significant aspect of effort, endeavor, enterprise and expense in logistics. For instance, a distributor may package products into parcels, which are addressed to recipients at various locations for delivery thereto by transport.

The parcels are then loaded onto trucks or other delivery vehicles. Delivery trucks are used herein as an example for representing any kind of delivery vehicle, which may operate over any transport mode or medium (e.g., land, air or water), without limitation. Efficiency in loading the parcels onto the trucks saves time, labor and cost.

Drivers and helpers thus strive to load out the parcel cargos for optimal efficiency. The cargo of the delivery trucks typically comprises multiple, perhaps dozens or more, of boxed parcels and other packages. Each of the parcels may conform to any of a variety of shapes, sizes, weights, form factors and other characteristics (e.g., fragilities).

Each of the variously shaped and sized parcels are placed on cargo shelves installed in the trucks, which may be retractable and/or configured for restraining or securing the packages in place. To most efficiently load the delivery truck, each of the variously shaped and sized parcels are to be placed optimally on installed cargo shelves.

Optimal placement of each of the various parcels on the cargo shelves involves a logically intensive approach by the drivers and helpers. The drivers typically load the parcels so as to maximize the efficient use of the cargo space, which serves for quickly locating and retrieving each of them upon arrival at its respective delivery destination.

Drivers typically perform cargo loading tasks based on their individual experience and intuition, which may vary significantly among them. Notwithstanding their particular levels of skill, experience, and foresight however, it is practically impossible for drivers to consistently optimize loading for every cargo apportioned within their trucks.

For example, drivers do not know all the box shapes and sizes for any particular cargo before or at the start of its loading process. This information deficit thus constrains optimal apportionment (e.g., best placement for each) of the individual parcels into the trucks' cargo space prior to any delivery run, much less one that lacks ready familiarity.

Drivers and their helpers may use spatial reasoning and ‘trial and error’ in arranging (and re-arranging) boxes optimally onto the trucks; perhaps with consideration as to their upcoming delivery route. Parcels may also be loaded however more or less haphazardly, which is more likely with time urgency and may have concomitant self-defeating ends.

Upon arrival at the destination for delivery of each of the parcels, the drivers are tasked to quickly recall the location within the truck at which the particular box being delivered is loaded among the other cargo. They then look to find that box therein, retrieve it quickly, safely dismount the truck therewith and provide it to its addressee.

Locating each parcel and retrieval thereof from among the cargo may pose some challenging tasks. The difficulty of the task may be exacerbated by the size and complexity of the cargo. Moreover, the costs and complexity associated with the location and retrieval tasks may increase with cargos that may have been subject to more haphazard loading.

Therefore, a need exists for providing guidance to drivers, helpers and others involved in apportioning each of multiple parcels among a cargo being loaded in a truck or other delivery vehicle, which optimizes efficiency in eventual retrieval of each of the parcels at their respective corresponding delivery destinations.

A need also exists for providing information for guiding the loading of each parcel of the cargo based on objective logistic criteria, e.g., apart from a driver's intuition or experience. Further, a need exists for providing the guidance for loading each parcel of the cargo objectively without adding unreasonable cost or complexity.

Issues and approaches discussed within this background section may, but not necessarily have, been conceived or pursued previously. Unless otherwise indicated to the contrary, it thus should not be assumed that anything discussed in this background section corresponds to any alleged prior art merely by inclusion in this discussion.

### SUMMARY

Accordingly, example embodiments of the present disclosure, in one aspect, embrace the provision of information for guiding those involved in apportioning each of multiple parcels among a cargo being loaded in a truck or other delivery vehicle, which optimizes efficiency in eventual retrieval of each of the parcels at their respective corresponding delivery destinations.

An example embodiment embraces the provision of such guidance for loading each parcel of a cargo based on objective logistic criteria, independent of the intuition or experience of a driver or other operator or their helpers. Example embodiments are also implemented to provide guidance for loading each parcel of a cargo objectively without adding unreasonable cost or complexity.

For example, embodiments of the present disclosure may thus allow faster loading of trucks and other delivery vehicles, more efficient use of space therein for the apportionment of their cargos, and/or faster picking, selection and/or retrieval of parcels, boxes and other cargo items from within the vehicles.

An example embodiment of the present invention relates to a method for presenting information relating to a position within a given delivery vehicle designated for transport of a particular cargo item therein. Information relating to a cargo, which comprises multiple parcels designated for loading into the given delivery vehicle, is evaluated. The particular cargo item comprises one of the multiple parcels.

The evaluation relates to at least one characteristic of each of the plurality of parcels and a capacity associated with the delivery vehicle. The information related to the position of the particular cargo item within the given delivery vehicle is computed logistically based on the evaluation of the cargo.

An entry of the particular cargo item into the given delivery vehicle is registered upon a loading, at least in part, of the cargo therein. Upon the registration of the particular cargo item, and based on the computation of the information, a visible identifier such as a laser beam is directed to the position designated for transport of the particular cargo item.

Visibility of the beam may be enhanced by diffused or other reflection thereof over a reflective surface, such as a retro-reflective tape strip or the like, which may be installed on or proximate to the particular cargo item.

In an example embodiment, a change in a geographic position corresponding to a location of the delivery vehicle is tracked in relation to a route over which the delivery vehicle travels. Based on the tracked geo-location, an approach and/or an arrival of the delivery vehicle location is detected in relation to a geographic position corresponding to a destination address designated for delivery of the particular cargo item.

The visible identifier is then redirected to the position designated for transport of the particular cargo item based on the detection of the arrival and/or the approach of the delivery vehicle to the geo-position corresponding to the designated delivery address.

The redirected visible identifier may be projected controllably by the laser pointer (or a projector), and may comprise information related to the delivery of the particular cargo item, such as special delivery instructions, warnings or the like. The visibility of the redirected visible identifier may be enhanced by projection onto the reflective surface.

An example embodiment relates to a non-transitory computer readable storage medium. The non-transitory computer readable storage medium comprises instructions, which are operable for causing a computer processor to perform a method for presenting information relating to a position within a given delivery vehicle designated for transport of a particular cargo item therein. The method may comprise steps such as those discussed above.

An example embodiment relates to a computer based system. The system is operable for presenting information related to a position within a given delivery vehicle designated for transport of a particular cargo item therein.

The system comprises a database component. The database is operable for storing information related to a cargo assigned to the delivery vehicle for loading therein and delivery therewith. The information is related to at least one characteristic of each of multiple parcels of the assigned cargo, of which the particular cargo item comprises one such parcel. The information also relates to a capacity associated with the delivery vehicle, such as a maximum number of parcels of given sizes the vehicle may transport efficiently.

A scanner component is operable for registering an entry of the particular cargo item into the given delivery vehicle upon loading, at least in part, of the cargo therein.

A computer component is communicatively coupled with the database. The computer is operable for accessing the information stored in relation to at least one characteristic of each of a plurality of parcels and a capacity associated with the delivery vehicle, for evaluating the cargo based on the accessed information, for computing logistically and, at least in relation to the particular cargo item, a position for transporting the particular cargo item within the given delivery vehicle based on the evaluation of the cargo, and for directing a presentation of the information related to a designation, based on the logistical computation, of the position for transport of the particular cargo item within the given delivery vehicle.

A pointer/projector component is directed by the computer and is thus operable therewith for presenting the information related to the designation of the position for transport of the particular cargo item within the given delivery vehicle.

In an example embodiment, the system also comprises a geo-positioning component, which is communicatively coupled with the computer. The geo-positioning component is operable for monitoring a geo-location of the delivery vehicle in relation to a route over which the delivery vehicle travels. The computer component may thus also operable for tracking a change in the geographic position corresponding to the location of the delivery vehicle in relation to the route over which it travels, based on the monitored geo-location of the delivery vehicle.

Based on the tracked geo-position change, the computer is operable for detecting an approach to, and/or arrival of the delivery vehicle at a location in relation to a geographic position corresponding to a destination address designated for delivery of the particular cargo item. The computer is thus further operable for redirecting the pointer/projector to redirect the visible identifier to the position designated for transport of the particular cargo item based on the detection of the approach/arrival of the delivery vehicle location in relation to the geographic position corresponding to the destination address designated for delivery of the particular cargo item.

An example embodiment may be implemented in which the pointer/projector is further operable for projecting information related to the delivery of the particular cargo item, and in which the computer is further operable for controlling the pointer/projector for the projection of the information related to the delivery of the particular cargo item.

The information related to the designation of the position for transport of the particular cargo item within the given delivery vehicle and/or the delivery related information may be projected by the pointer/projector component onto a reflective surface on or proximate to the position designated for transport of the particular cargo item.

An example embodiment may also be implemented in which the scanner is further operable for registering a delivery of the particular cargo item upon a removal thereof from the given delivery vehicle. The scanner may also be operable for updating the computer component and/or the database component in relation to the registered delivery of the particular cargo item.

The foregoing illustrative summary, as well as other examples described in relation to embodiments of the present invention, and the manner in which the same are implemented and/or accomplished, are further explained within the more detailed description and its accompanying drawing figures, which are set forth below.

### BRIEF DESCRIPTION OF THE DRAWINGS

FIG. 1 depicts an example delivery vehicle cargo compartment, with which according to an embodiment of the present disclosure may be practiced;

FIG. 2 depicts schematically depicts an example computer based system, according to an embodiment of the present disclosure;

FIG. 3 depicts an example computer and network platform, with which an embodiment of the disclosure may be implemented;

FIG. 4 depicts a flowchart for an example process, according to an embodiment of the present disclosure; and

FIG. 5 depicts an example use of providing information related to the delivery of parcels, according to an embodiment of the present disclosure.

### DETAILED DESCRIPTION OF EXAMPLE EMBODIMENTS

Example embodiments of the present invention are described in relation to optimizing cargo apportionment. An example embodiment of the present invention relates to the provision of information for guiding those involved in an apportionment of each of multiple parcel items among a cargo being loaded into a truck or other delivery vehicle. A logistically optimal location is thus indicated for positioning each parcel for transport and delivery. The provision of the information for guiding the loading optimizes efficiency in eventually retrieving each of the parcels at their respective corresponding delivery destinations.

Embodiments provide information for guiding the loading of the parcels into a cargo for delivery based on objective logistic criteria. The logistic criteria are computed independent of the intuition or experience of a driver (or operator of any delivery vehicle) or their helpers, and unreasonably additional expenses and/or complexities. Embodiments of the present invention may thus allow faster loading of trucks and other delivery vehicles, more efficient use of space therein for the apportionment of their cargos, and/or faster picking, selection and/or retrieval of parcels, boxes and other cargo items from within the vehicles.

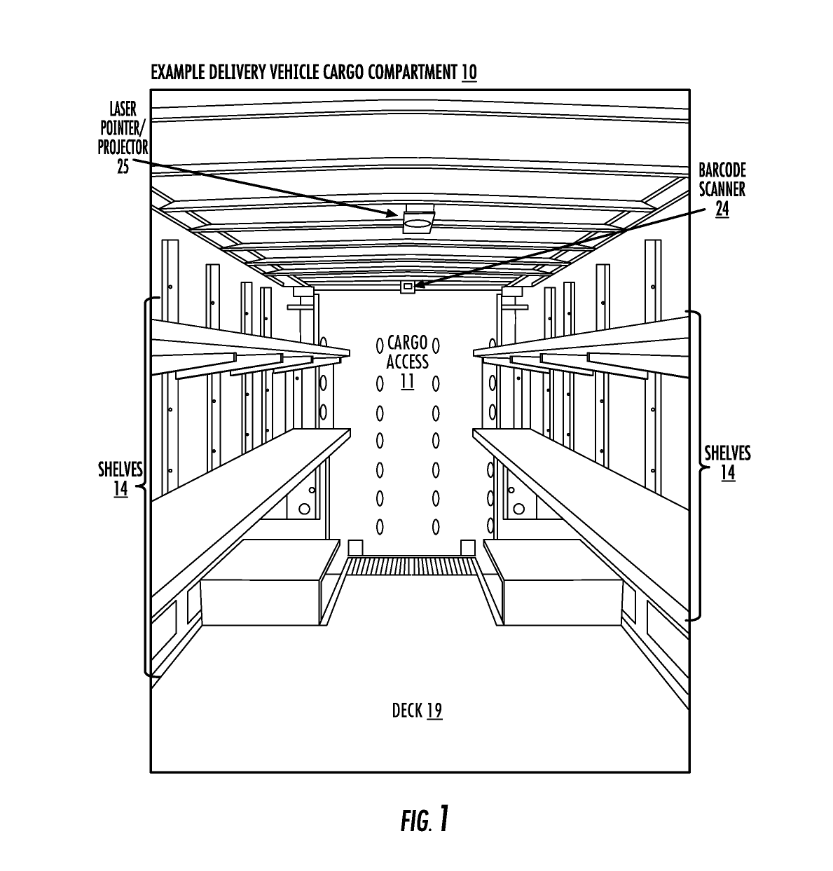

FIG. 1 depicts an example delivery vehicle cargo compartment 10, with which according to an embodiment of the present invention may be practiced. The cargo compartment 10 may comprise a bay, disposed within an example delivery truck, and in which parcels are transported. The cargo compartment 10 may comprise a cargo access door 11, which may be disposed at one or more ends or sidewalls thereof. A bar code scanner 24 may be disposed at or near the access 11 and operable for scanning barcodes, with which parcels being loaded into the compartment 10 are labelled.

Shelves 14, which may be retractable, foldable and/or otherwise adjustable, are disposed along one or more inner walls or bulkheads of cargo compartment 10. Parcels may be transported as cargo on the shelves 14 and/or on a deck 19, which forms a floor of the cargo compartment 10. A laser pointer and/or projector 25 is disposed on the inner surface of an overhead or ceiling, which is opposite to the deck 19. The laser pointer/projector 25 is operable for pointing to individual parcels at the delivery location thereof and for projecting information relating to the delivery of the parcel.

Within this description, delivery trucks are used as an example for representing any kind of delivery vehicle. Example embodiments of the present invention are well suited and intended for use in loading cargo items into any kind of delivery vehicle, without limitation, which are represented herein by the example delivery trucks. It should be understood that the delivery vehicles with which example embodiments are used may operate, without limitation, over any mode of transportation and/or transport medium (e.g., land, air or water). Efficiency gained in loading the parcels onto the trucks and/or other delivery vehicles according to example embodiments may save time, reduce labor efforts, and/or economize on expenses relative to typical cargo loading techniques, which may be associated with conventional approaches thereto.

The bar code scanner 24, and the laser pointer/projector 25, are operable respectively for tracking each parcel as it is loaded and pointing thereto upon the delivery truck reaching its delivery destination. An example embodiment of the present invention may be implemented wherein the bar code scanner and the laser pointer/projector 25 comprise components of a computer based system. The pointer/projector 25 may comprise a directed laser pointer and/or projector device, which illuminates reflective tape with which each parcel, or locations within the cargo bay of the truck in proximity thereto, is labelled.

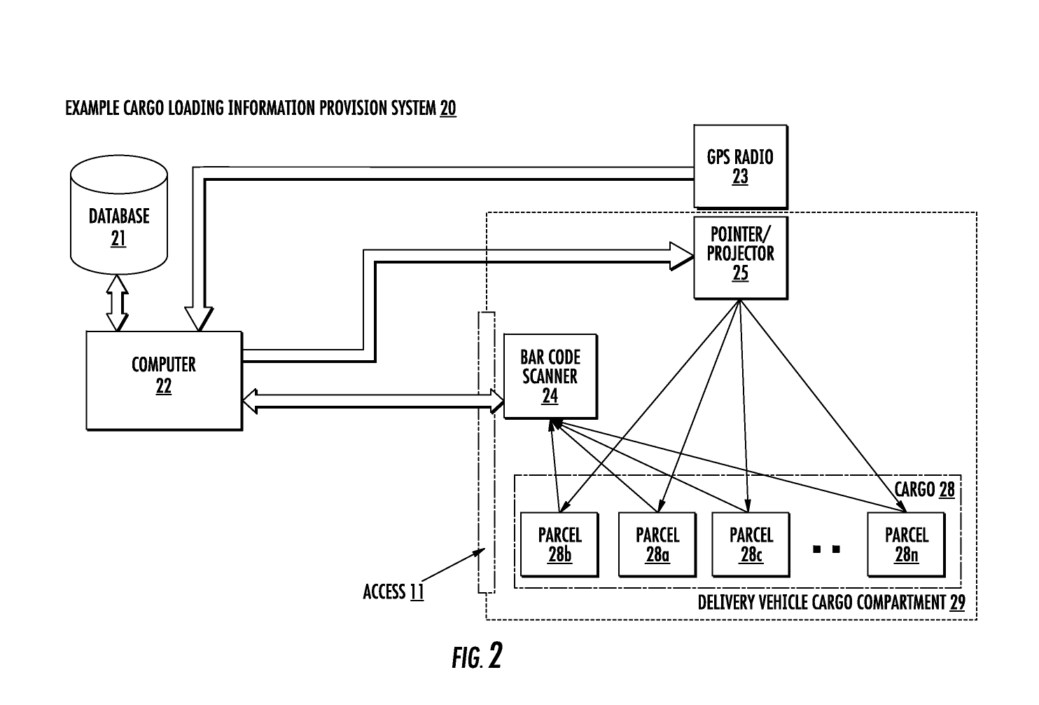

FIG. 2 depicts schematically an example system 200, according to an embodiment of the present invention. The system 20 comprises a computer 21, which is operable with the bar code scanner 24 for tracking each parcel loaded into the compartment 10, e.g., as it passes into the compartment through the access 11.

Data relating to any or all of the characteristics of each parcel of a particular cargo are stored in a database 21, to which the computer 22 has access. Such data may relate to information including dimensions, weight, and destination. The data may also comprise other information, which may be pertinent to particular parcels such as special handling or delivery instructions and/or warnings relating to fragility or other attributes of the parcels.

As each of the parcels is loaded through the access door 11, the bar code scanner 24 reads a bar code with which it is uniquely labelled and identifies it to the computer 21, which accesses the data relating thereto from the database 21. Based on the data, the computer 22 may compute a logistically optimal placement location within the cargo compartment 11 for transporting each to their delivery destinations, with which retrieval, offloading and delivery may be most efficiently achieved. Based on the computed optimal placement location, the computer 22 controls the laser pointer/projector 25 to visually identify or “point to” the optimal location for the driver or helpers to place each parcel for transport with a directed laser beam.

For example, a particular cargo 28 may comprise a plurality of parcels 28a, 28b, 28c, . . . , 28n, inclusive. Based on the logistical data retrieved from the database 21, the computer 22 directs a laser beam to the optimal placement location within the stack of cargo 28 for each of the parcel items. The laser projector 25 may point to a spots optimal for one or more of the packages, which may otherwise not be obvious or intuitive, or even reasonably knowable to the driver or helpers loading the cargo 28. Thus, the positions of two or more of the parcels (e.g., parcel 28a and parcel 28b) may be reversed in placement, relative to how most loaders may otherwise place them (e.g., in a more serial order, which while less optimal logistically, may otherwise seem more apparent to the loaders). Positioning the parcels for transport based on the computed logistical optimization however may be expected to make delivery of each parcel more efficient.

The barcode scanner 24 is fixedly or removably mounted just inside the back door of the truck and is used to scan boxes as they enter or leave the truck. An example embodiment may also be implemented in which the barcode scanner 24 is portable and used by the driver manually for scanning each parcel as it is loaded and delivered. The scanner 24 may be communicatively coupled to the computer 21 by wireline or wirelessly.

The barcode scanner 24 may be operable for reading any of a variety of 2D (two dimensional) barcode patterns, including, e.g., PDF417 barcodes and/or QR (quick read) code patterns. Barcode patterns and scanners thereof are used herein for example. An embodiment may also be implemented using RFID (radio frequency identification) tags with, or in place of the bar codes. The scanner 24 may also be portable. Portable scanners and removably mounted scanners may be carried by drivers and scans performed therewith manually.

A radio 23 using GPS (Global Positioning System) or other geolocation technology is disposed in the truck and is operable for keeping the computer 21 informed and up to date in relation to the location of the delivery vehicle. The computer 21 is thus informed as the truck reaches or approaches the delivery location for each of the parcels.

Upon reaching or approaching its delivery location, the pointer/projector 25 is controlled by the computer 21 to redirect (e.g., direct again, relative to original direction of the beam at load time) the laser beam to illuminate the particular parcel. Reflective tape with which the parcel is labelled may enhance the laser beam's visibility and direct the driver's attention visibly thereto, which thus facilitates (e.g., speeds and eases) its ready retrieval.

The reflective tape may also be affixed along the edges of each of the shelves 14, lining the walls or bulkheads of the cargo compartment 10 and is operable for enhancing the visibility of the light beams directed or projected by the laser pointer and/or projector 25, rendering the light more readily viewable by the driver.

The pointer/projector 25 may also be operable to emit light at non-visible infrared wavelengths and safely at very low intensity levels. Thus, an example embodiment may also be implemented in which the reflective tape comprises quantum dots or other materials and may thus be operable for rendering the infrared output of the laser/projector 25 perceivable to the driver at a visible wavelength.

The pointer/projector 25 may also comprise a projector, operable for projecting special delivery instructions in relation to each parcel. The special instructions may relate to warnings associated with the parcel and/or to delivery quantities, such as “1 of 2 and 2 or 2,” etc.

An example embodiment may be implemented in which the computer 22 and/or the database 21 are disposed together or otherwise and at, or distributed over one or more stationary locations, such as a base station or a cargo depot.

Example embodiments may also be implemented in which the computer 22 is disposed in the truck, or with a portable data terminal (PDT), a tablet or another computer associated with the driver. The portable computer or PDT may also comprise the bar code (or RFID) scanner 24 and/or the GPS radio 23. An example embodiment may also be implemented in which the computer 22 comprises a PDT, tablet or other component and a remote base computer such as a more or less stationary PC or workstation type in communication therewith, e.g., wirelessly.

Thus, the computer 22 gathers data from the database 21, the scanner 24 and the GPS radio 23, and directs the location of aim of its beam and illumination of the laser pointer/projector 25 according to the gathered data.

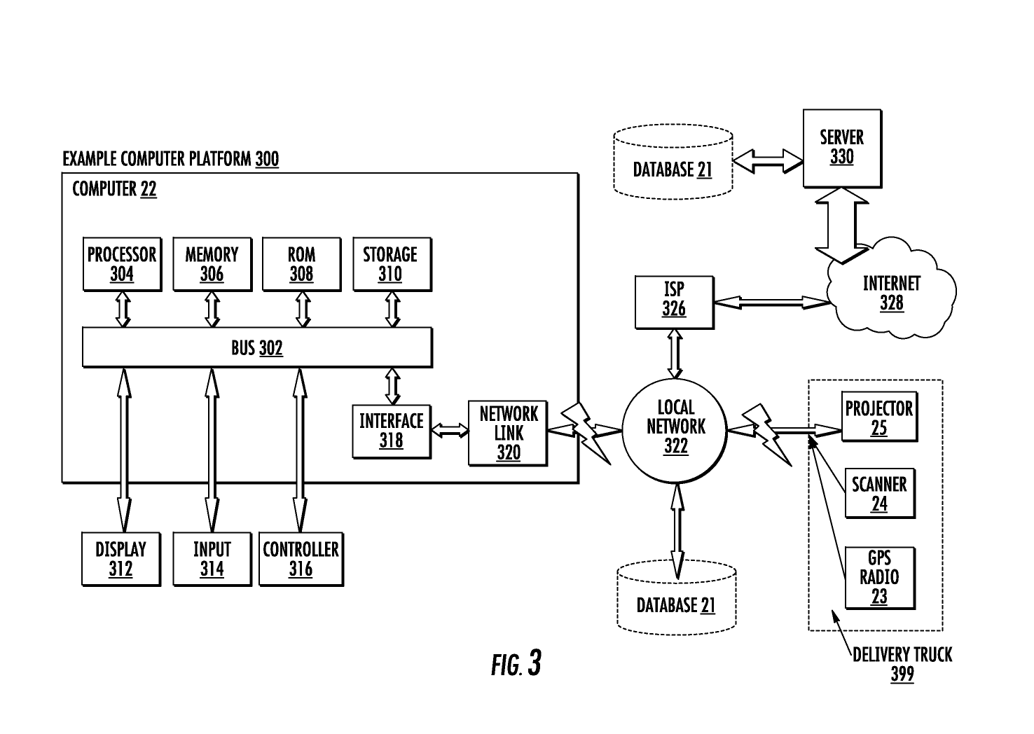

FIG. 3 depicts example computer and network platforms 300, with which an embodiment of the invention may be implemented. For example, the computer 22 and the database 21 may each comprise a computer and/or exchange data via networks, which may be represented at least in relation to some aspects thereof with reference to FIG. 3.

The computer 22 may control the pointer/projector 25, receive scans from the barcode (or RFID) scanner as it reads barcode (or RFID) labels or tags on parcels as they are loaded into and delivered from a delivery truck 399 and/or receive geolocation signals relating to the delivery truck 399 and parcels among the cargo therein. Computer 22 communicates with the pointer/scanner 25, the barcode scanner 24 and the GPS radio 23 via a network link 320 and the local network 322, or via another network.

The computer 22 may be operable for processing data in relation to an algorithm, program, and/or application related to logistics, linear programming, operations management or the like.

The computer 22 comprises a bus 302 or other communication mechanism for communicating information, and a processor 304 coupled with bus 302 for processing information. Computer 22 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304.

Computer 22 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions. Processor 304 may perform one or more digital signal processing (DSP) functions. Additionally or alternatively, DSP functions may be performed by another processor or entity (represented herein with processor 304).

Computer 22 may be coupled via bus 302 to a display 312, such as a modern liquid crystal display (LCD), older cathode ray tube (CRT) types, plasma displays, “thin” (or “cold cathode”) CRTs, or the like, for displaying information to a computer user. In some PDT applications, LCDs or thin CRTs may be used with some regularity.

An input device 314, including alphanumeric (and/or other) symbols and other keys, is coupled to bus 302 for communicating information and command selections to processor 304. Another type of user input device is cursor control 316, such as haptic-enabled “touch-screen” or “mouse pad” GUI displays or a mouse, a trackball, or cursor direction keys for communicating direction information and command selections to processor 304 and for controlling cursor movement on display 312.

Such input devices typically have two degrees of freedom in two axes, a first axis (e.g., x) and a second axis (e.g., y), which allows the device to specify positions in a plane. Some phones with simpler keyboards may implement this or a similar feature haptically using a touch-screen GUI display and/or with a set of directionally active “arrow” keys.

Embodiments of the present disclosure relate to the use of computer 22 for identifying logistically optimal locations for transporting parcels among cargo, and for visually identifying the parcels among the cargo for efficient retrieval at their respective delivery destinations, and other embodiments described herein. This feature is provided, controlled, enabled or allowed with computer 22 functioning in response to processor 304 executing one or more sequences of one or more instructions contained in main memory 306.

Such instructions may be read into main memory 306 from another computer-readable medium, such as storage device 310. Execution of the sequences of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware, circuitry, firmware and/or software.

An example embodiment relates to a non-transitory computer readable storage medium. The non-transitory computer readable storage medium comprises instructions, which are operable for causing a computer processor to perform a method for presenting information relating to a position within a given delivery vehicle designated for transport of a particular cargo item therein.

The terms “computer-readable medium” and/or “computer-readable storage medium” as used herein may refer to any non-transitory storage medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and other conductors and fiber optics, including the wires (or other conductors or optics) that comprise bus 302. Transmission media can also take the form of acoustic (e.g., sound) or electromagnetic (e.g., light) waves, such as those generated during radio wave and infrared and other optical data communications.

Common or familiar forms of non-transitory computer-readable storage media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of non-transitory computer readable storage media may be involved in carrying one or more sequences of one or more instructions to processor 304 for execution. For example, the instructions may initially be carried on a magnetic disk of a remote computer (e.g., server 330). The remote computer can load the instructions into its dynamic memory and send the instructions over a telephone line and/or network, e.g., using a modem (modulator/demodulator).

A modem local to the computer 22 can receive the data over networks wirelessly and/or on wireline (e.g., coaxial cable, fiber optics, telephone lines, etc.) and use an infrared or other transmitter to convert the data to an infrared or other signal. An infrared or other detector coupled to bus 302 can receive the data carried in the infrared or other signal and place the data on bus 302. Bus 302 carries the data to main memory 306, from which processor 304 retrieves and executes the instructions. The instructions received by main memory 306 may optionally be stored on storage device 310 either before or after execution by processor 304.

Computer 22 also includes a communication interface 318 coupled to bus 302. Communication interface 318 provides a two-way data communication coupling to a network link 320 that is connected to a local network 322. For example, communication interface 318 may comprise a cable modem or a DSL (digital subscription line), or legacy media such as ISDN (integrated services digital network) cards, or other modem types to provide a data communication connection to a corresponding type of telephone line or wireless medium. As another example, communication interface 318 may comprise a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) (or telephone switching company) 326. In an embodiment, local network 322 may comprise a communication medium with which a user's telephone functions. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer 22, are exemplary forms of carrier waves transporting the information.

Computer 22 can send messages and receive data, including program code, through the network(s), network link 320 and communication interface 318.

For example, computer 22 communicates with the pointer/scanner 25, the barcode scanner 24 and the GPS radio 23 via a network link 320 and the local network 322, or via another network. Computer 22 may thus control the laser pointer/projector 25, receive scans from the barcode scanner as it reads barcode labels on parcels as they are loaded into and delivered from a delivery truck 399 and/or receive geolocation signals relating to the delivery truck 399 and parcels among the cargo therein.

In the Internet example, a server 330 might transmit a requested code for an application program related to logistics or other computations through Internet 328, ISP 326, local network 322 and communication interface 318. In an embodiment of the invention, one such downloaded application provides for identifying logistically optimal locations for transporting parcels among cargo, and for visually identifying the parcels among the cargo for efficient retrieval at their respective delivery destinations.

The received code may be executed by processor 304 as it is received, and/or stored in storage device 310, or other non-volatile storage for later execution. In this manner, computer 22 may obtain application code in the form of a carrier wave.

Computer 22 thus gathers data from the database 21, the scanner 24, and the GPS radio 23, and directs the location and illumination of the laser pointer according to the gathered data. An example embodiment may be implemented in which computer 22 gathers data from the database 21, the scanner 24 and/or the GPS radio 23 via the local network 322 and the network link 320, etc.

An example embodiment may also be implemented in which the computer 22 gathers data from the database 21 by means of queries directed via the server 330 and over the internet (or other network) 328, as well as the local network 322 and network link 320, etc.

An example embodiment is thus described in relation to a computer based system. The system is operable for presenting information related to a position within a given delivery vehicle designated for transport of a particular cargo item therein.

The system comprises a database. The database is operable for storing information related to a cargo assigned to the delivery vehicle for loading therein and delivery therewith. The information is related to at least one characteristic of each of multiple parcels of the assigned cargo, of which the particular cargo item comprises one such parcel. The information also relates to a capacity associated with the delivery vehicle, such as a maximum number of parcels of given sizes the vehicle may transport efficiently.

A scanner is operable for registering an entry of the particular cargo item into the given delivery vehicle upon loading, at least in part, of the cargo therein.

A computer is communicatively coupled with the database. The computer is operable for accessing the information stored in relation to at least one characteristic of each of a plurality of parcels and a capacity associated with the delivery vehicle, for evaluating the cargo based on the accessed information, for computing logistically and, at least in relation to the particular cargo item, a position for transporting the particular cargo item within the given delivery vehicle based on the evaluation of the cargo, and for directing a presentation of the information related to a designation, based on the logistical computation, of the position for transport of the particular cargo item within the given delivery vehicle.

A pointer is directed by the computer and is thus operable therewith for presenting the information related to the designation of the position for transport of the particular cargo item within the given delivery vehicle.

In an example embodiment, the system also comprises a geo-positioning component, which is communicatively coupled with the computer. The geo-positioning component is operable for monitoring a geo-location of the delivery vehicle in relation to a route over which the delivery vehicle travels. The computer component may thus also operable for tracking a change in the geographic position corresponding to the location of the delivery vehicle in relation to the route over which it travels, based on the monitored geo-location of the delivery vehicle.

Based on the tracked geo-position change, the computer is operable for detecting an approach to, and/or arrival of the delivery vehicle at a location in relation to a geographic position corresponding to a destination address designated for delivery of the particular cargo item. The computer is thus further operable for redirecting the pointer component to point a visible identifier to the position designated for transport of the particular cargo item based on the detection of the approach/arrival of the delivery vehicle location in relation to the geographic position corresponding to the destination address designated for delivery of the particular cargo item.

An example embodiment may be implemented in which the pointer is further operable for projecting information related to the delivery of the particular cargo item, and wherein the computer component is further operable for controlling the pointer component for the projection of the information related to the delivery of the particular cargo item.

The information related to the designation of the position for transport of the particular cargo item within the given delivery vehicle and/or the delivery related information may be projected by the pointer/projector component onto a reflective surface on or proximate to the position designated for transport of the particular cargo item.

An example embodiment may also be implemented in which the scanner component is further operable for registering an delivery of the particular cargo item upon a removal thereof from the given delivery vehicle. The scanner may also be operable for updating the computer component and/or the database component in relation to the registered delivery of the particular cargo item.

Example embodiments may relate to implementing various applications and use cases. The computer 22 for example accesses the database 21, the code pattern scanner 24, and GPS or other geo-positioning radio 23, and operating based on information obtained therefrom, computes a location for all of the boxes, packages and parcels, including a particular cargo item, which comprise elements of a cargo to be loaded and transported in a given delivery vehicle.

The computation may thus be based, at least partially, on characteristics associated with each cargo item within the vehicle, including the particular cargo item. The characteristics may include for example, box geometry and weight, size (e.g., absolute and/or relative to each of the other cargo items), special attributes (e.g., fragility, sensitivity, flammability or other attributes that may pose risks or impose extraordinary handling requirements) and/or delivery instructions (e.g., part of a multiple delivery, priority handling demands).

The computation may also be based, at least partially, on properties or characteristics of the truck or other delivery vehicle and/or its cargo bay(s), such as dimensions and capacity. Processing data relating to the characteristics of the cargo items and the properties of the delivery truck, the computation may comprise an algorithm, program, and/or application related to logistics, linear programming, operations management or the like.

A first use case relates to loading the truck or other delivery vehicle. As the truck is loaded, each box is scanned as it is loaded. The scanner 24 may be mounted as a component of the truck and used in place. Scanner 24 may be fixedly or removable mounted on the truck or portable. The portable scanner may be carried by the driver, helper or other loaders and used manually. The removably mounted scanner may be used while mounted on the truck or removed from its mounting and carried by the driver and used to scan each of the cargo items manually. Based on the logistical computation, the computer 22 directs the laser pointer/projector 25.

Under control of the computer 22, the laser pointer/projector 25 illuminates a specific location on the shelves 14, the deck 19 or elsewhere, which is designated for placement of the specific cargo item for transport to its delivery destination. Thus, the driver may be directed to a logistically optimal location within for placing the box, which is designed to facilitate delivery thereof.

Upon placing the parcel, package, box or other cargo item in its designated location, another cargo item may thus be loaded based on the same routine.

A second use case relates to delivering the particular cargo item to its destination and the corresponding removal of that cargo item from the delivery truck. Based on the interaction of the geo-location radio 23 and the computer 22, delivery of each of the cargo items is achieved with location awareness. As the delivery truck approaches or arrives at the delivery destination of the particular cargo item, the computer 22 controls the laser pointer/projector 25 to illuminate the location of that particular cargo item.

The laser pointer/projector 25 redirects its beam to a surface of the box or other package of the cargo item, itself and/or a reflective surface. The reflective surface may comprise retro-reflective tape or labelling. The reflective label or tape may be affixed to the cargo item surface and/or to a portion of a shelf 14 or deck 19 corresponding to that cargo item's designated transport location. The laser beam thus draws attention visually to the designated cargo item, so as to facilitate its ready retrieval from among the other cargo stowed therewith in the cargo bay of the truck.

Upon arrival at delivery destination of the particular cargo item, the driver parks the delivery truck and proceeds to retrieve the item from its cargo space. The driver visually identifies the particular cargo item from among the other cargo stowed therewith based on the illumination. The driver may thus quickly find and retrieve the particular cargo item to be delivered.

Further, the pointer/projector 25 may project other information visibly. The projected information may relate for example to regular and/or special delivery instructions, special handling instructions and/or other information relevant to the particular content item and its delivery.

The retrieved cargo item is scanned. The cargo item (e.g., a label affixed thereto bearing a bar code pattern) may be scanned by the fixedly or removably mounted scanner 24 upon removal of the item from the truck for delivery. The cargo item may also be scanned manually by the driver using a portable scanner or while carrying the removably mountable scanner, either upon removal of the cargo item from the truck or upon retrieval thereof from among the other cargo items. Delivery of the particular cargo item is thus registered with the computer 22 and the database 21 may be updated accordingly.

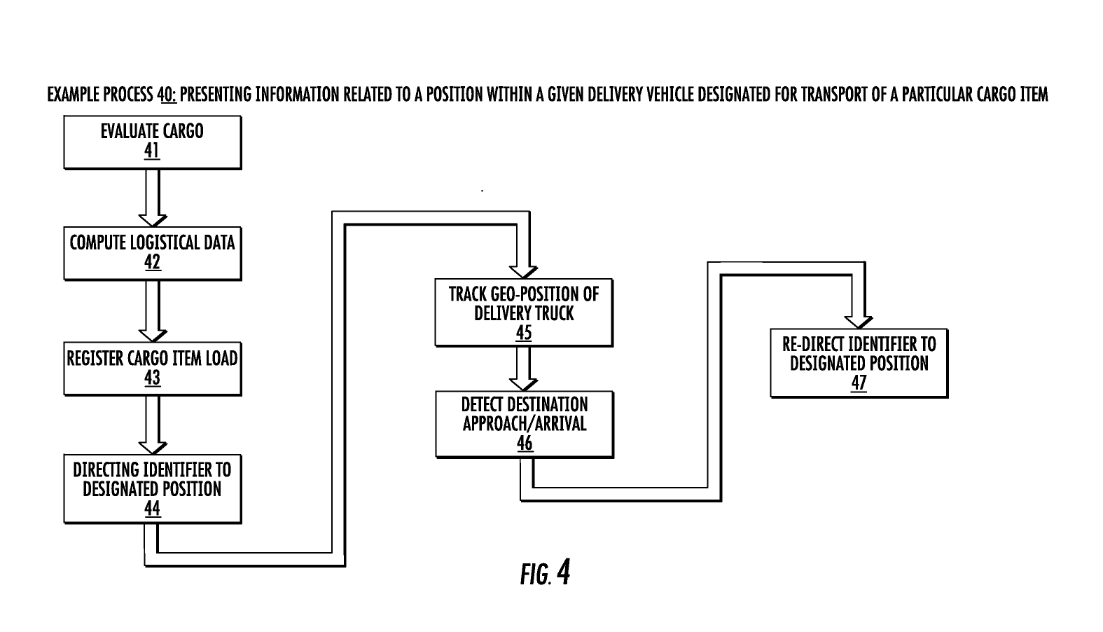

FIG. 4 depicts a flowchart for an example process 40, according to an embodiment of the present invention. Process relates to the presentation of information. The information presented is related to a position within a given delivery vehicle, which is designated for transport of a particular cargo item therein.

In step 41, a cargo is evaluated (e.g., analyzed). The cargo comprises multiple parcels designated for loading into the given delivery vehicle. The particular cargo item comprises one of the multiple parcels. The evaluation relates to at least one characteristic of each of the multiple parcels and a capacity, which is associated with the delivery vehicle.

In step 42, logistical data corresponding to information related to the position of the particular cargo item within the given delivery vehicle is computed based on the evaluation of the cargo step.

In step 43, loading of the particular cargo item is registered, e.g., by a computer and/or a database operable therewith upon its entry into the given cargo delivery vehicle. Registering the particular cargo item occurs upon load of the particular cargo item into the given delivery vehicle upon loading, at least partially, the cargo into the delivery truck.

In step 44, a visible identifier is directed to the position designated for transport of the particular cargo item upon its registration, and based on the computation of the information.

In an example embodiment, a change in a geographic position corresponding to a location of the delivery vehicle is tracked in step 45, relative to a route over which the delivery vehicle travels.

In step 46 then, an approach to and/or an arrival at a geographic position corresponding to a destination address designated for delivery of the particular cargo item is detected based on the tracked vehicle geo-position.

In step 47, the visible identifier is controllably redirected to the position designated for transport of the particular cargo item based on the detecting the arrival or the approach step, which may facilitate its fast and simple retrieval for delivery.

An example embodiment thus relates to a method for presenting information, which is related to a position within a given delivery vehicle designated for transport of a particular cargo item therein. Information relating to a cargo, which comprises multiple parcels designated for loading into the given delivery vehicle is evaluated. The particular cargo item comprises one of the multiple parcels.

The evaluation relates to at least one characteristic of each of the plurality of parcels and a capacity associated with the delivery vehicle. The information related to the position of the particular cargo item within the given delivery vehicle is computed logistically based on the evaluation of the cargo.

An entry of the particular cargo item into the given delivery vehicle is registered upon a loading, at least in part, of the cargo therein. Upon the registration of the particular cargo item, and based on the computation of the information, a visible identifier such as a laser beam is directed to the position designated for transport of the particular cargo item.

Visibility of the beam may be enhanced by diffused or other reflection thereof over a reflective surface, such as a retro-reflective tape strip or the like, which may be installed on or proximate to the particular cargo item.

In an example embodiment, a change in a geographic position corresponding to a location of the delivery vehicle is tracked in relation to a route over which the delivery vehicle travels. Based on the tracked geo-location, an approach and/or an arrival of the delivery vehicle location is detected in relation to a geographic position corresponding to a destination address designated for delivery of the particular cargo item.

The visible identifier is redirected to the position designated for transport of the particular cargo item based on the detection of the arrival and/or the approach of the delivery vehicle to the geo-position corresponding to the designated delivery address.

The redirected visible identifier may be projected controllably by the laser (or a projector), and may comprise information related to the delivery of the particular cargo item, such as special delivery instructions, warnings or the like. The visibility of the redirected visible identifier may be enhanced by projection onto the reflective surface.

An example embodiment relates to a non-transitory computer readable storage medium. The non-transitory computer readable storage medium comprises instructions, which are operable for causing a computer processor to perform a method for presenting information relating to a position within a given delivery vehicle designated for transport of a particular cargo item therein. The method may comprise steps such as those described above in relation to FIG. 4.

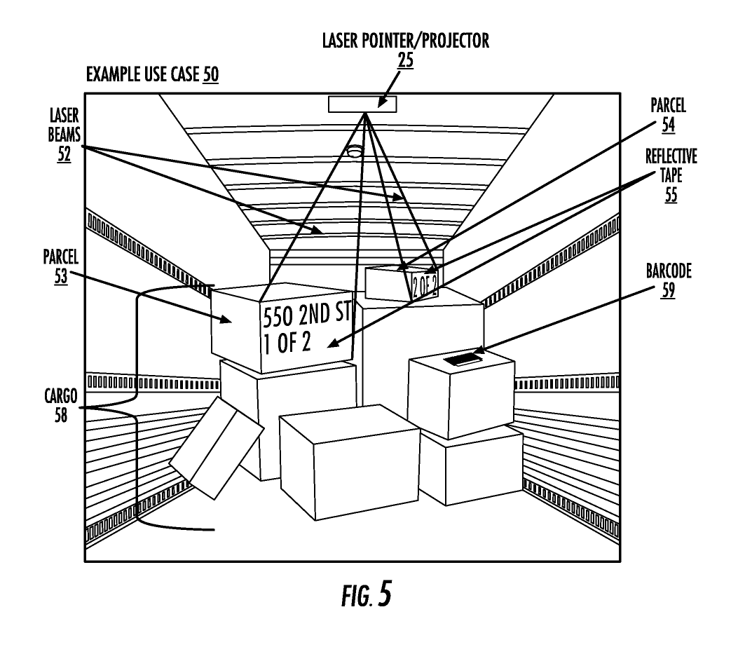

FIG. 5 depicts an example use case 50, which relates to providing information related to the delivery of parcels, according to an embodiment of the present disclosure. A cargo is depicted as stowed in a cargo area of an example delivery truck. The cargo 58 comprises multiple boxes and packages, including a first parcel 53 and a second parcel 54.

The parcels 53 and 54 comprise a pair of particular items of the cargo 58, which are designated for delivery together to an assigned destination address. As the tracked geo-location of the delivery truck approaches, or arrives at a geo-location corresponding to the destination address of the pair of particular cargo items 53 and 54, the pointer/projector 25 is controlled by the computer 22 to redirect its optical output to the parcels.

The optical output of the pointer/projector 25 comprises laser beams 52, with which the parcels 53 and 54 are illuminated visibly to attract the driver's attention and thus facilitate their ready retrieval. Moreover, the pointer/projector 25 projects delivery instructions on or proximate to each of the parcels 53 and 54.

The delivery instructions comprise a delivery address, e.g., “550 2nd St.” and special information pertinent to delivery of the parcels 53 and 54. The special delivery instructions relate to parcel 53 comprising the first item of a pair of items for delivery to the designated address, and to parcel 54 comprising the second item of the pair of items for delivery thereto. The pointer/projector 25 may direct the laser beams 52 to a reflective surface 55, such as a label affixed on (or proximate to) the parcels 53 and 54.

A label bearing a unique bar code pattern 59 (or unique RFID tag) may be affixed to each of the cargo items, including the parcels 53 and 54. The bar code patterns are scanned upon loading each of the cargo items into the truck and upon delivery to their destinations, which allows computer 22 to track each of the cargo items and update database 21 accordingly

Thus, example embodiments of the present invention have been described, which may effectively reduce labor and costs, relative to aspects of logistics relating to the delivery of parcels and other cargo components. Information is provided for guiding those involved in apportioning each of multiple parcels among a cargo being loaded in a truck or other delivery vehicle, which optimizes efficiency in eventual retrieval of each of the parcels at their respective corresponding delivery destinations.

An example embodiment embraces the provision of such guidance for loading each parcel of a cargo based on objective logistic criteria, independent of the intuition or experience of a driver or other operator or their helpers. Example embodiments are also implemented to provide guidance for loading each parcel of a cargo objectively without adding unreasonable cost or complexity.

For example, embodiments of the present disclosure may thus allow faster loading of trucks and other delivery vehicles, more efficient use of space therein for the apportionment of their cargos, and/or faster picking, selection and/or retrieval of parcels, boxes and other cargo items from within the vehicles.

An example embodiment of the present disclosure has thus been described in relation to presenting information relating to positions within delivery vehicles and designated for transporting particular items of a multi-parcel cargo. Cargo-related information is evaluated in relation characteristic(s) of each parcel. The information for transport-positioning the cargo item is computed based on the evaluation. Entry of the cargo item is registered upon loading and an identifier is visibly directed to its transport position. Geo-positioning of the vehicle is tracked its route. Destination approach/arrival is detected based on the tracking and the visible identifier is redirected to the item's position. The identifier may be projected controllably by the laser/projector, including delivery related information (e.g., related to delivery, warnings, etc.). Visibility may be enhanced using reflective surfaces.

In the specification and/or figures, example embodiments of the invention have been disclosed. Embodiments of the present invention however are not limited to such examples. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

To supplement the present disclosure, this application incorporates entirely by reference the following patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,526;
U.S. Pat. No. 8,798,367; U.S. Pat. No. 8,807,431;
U.S. Pat. No. 8,807,432; U.S. Pat. No. 8,820,630;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2011/0202554;
U.S. Patent Application Publication No. 2012/0111946;
U.S. Patent Application Publication No. 2012/0138685;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0056285;
U.S. Patent Application Publication No. 2013/0070322;
U.S. Patent Application Publication No. 2013/0075168;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0200158;
U.S. Patent Application Publication No. 2013/0256418;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0278425;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306730;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0341399;
U.S. Patent Application Publication No. 2013/0342717;
U.S. Patent Application Publication No. 2014/0001267;
U.S. Patent Application Publication No. 2014/0002828;
U.S. Patent Application Publication No. 2014/0008430;
U.S. Patent Application Publication No. 2014/0008439;
U.S. Patent Application Publication No. 2014/0025584;
U.S. Patent Application Publication No. 2014/0027518;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061305;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0075846;
U.S. Patent Application Publication No. 2014/0076974;
U.S. Patent Application Publication No. 2014/0078341;
U.S. Patent Application Publication No. 2014/0078342;
U.S. Patent Application Publication No. 2014/0078345;
U.S. Patent Application Publication No. 2014/0084068;
U.S. Patent Application Publication No. 2014/0097249;
U.S. Patent Application Publication No. 2014/0098792;
U.S. Patent Application Publication No. 2014/0100774;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0108682;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0160329;
U.S. Patent Application Publication No. 2014/0166755;
U.S. Patent Application Publication No. 2014/0166757;
U.S. Patent Application Publication No. 2014/0166759;
U.S. Patent Application Publication No. 2014/0166760;
U.S. Patent Application Publication No. 2014/0166761;
U.S. Patent Application Publication No. 2014/0168787;
U.S. Patent Application Publication No. 2014/0175165;
U.S. Patent Application Publication No. 2014/0175169;
U.S. Patent Application Publication No. 2014/0175172;
U.S. Patent Application Publication No. 2014/0175174;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0203087;
U.S. Patent Application Publication No. 2014/0204268;
U.S. Patent Application Publication No. 2014/0214631;
U.S. Patent Application Publication No. 2014/0217166;
U.S. Patent Application Publication No. 2014/0217180;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/436,337 for an Electronic Device, filed Nov. 5, 2012 (Fitch et al.);
U.S. patent application Ser. No. 13/771,508 for an Optical Redirection Adapter, filed Feb. 20, 2013 (Anderson);
U.S. patent application Ser. No. 13/852,097 for a System and Method for Capturing and Preserving Vehicle Event Data, filed Mar. 28, 2013 (Barker et al.);
U.S. patent application Ser. No. 13/902,110 for a System and Method for Display of Information Using a Vehicle-Mount Computer, filed May 24, 2013 (Hollifield);
U.S. patent application Ser. No. 13/902,144, for a System and Method for Display of Information Using a Vehicle-Mount Computer, filed May 24, 2013 (Chamberlin);
U.S. patent application Ser. No. 13/902,242 for a System For Providing A Continuous Communication Link With A Symbol Reading Device, filed May 24, 2013 (Smith et al.);
U.S. patent application Ser. No. 13/912,262 for a Method of Error Correction for 3D Imaging Device, filed Jun. 7, 2013 (Jovanovski et al.);
U.S. patent application Ser. No. 13/912,702 for a System and Method for Reading Code Symbols at Long Range Using Source Power Control, filed Jun. 7, 2013 (Xian et al.);
U.S. patent application Ser. No. 29/458,405 for an Electronic Device, filed Jun. 19, 2013 (Fitch et al.);
U.S. patent application Ser. No. 13/922,339 for a System and Method for Reading Code Symbols Using a Variable Field of View, filed Jun. 20, 2013 (Xian et al.);
U.S. patent application Ser. No. 13/927,398 for a Code Symbol Reading System Having Adaptive Autofocus, filed Jun. 26, 2013 (Todeschini);
U.S. patent application Ser. No. 13/930,913 for a Mobile Device Having an Improved User Interface for Reading Code Symbols, filed Jun. 28, 2013 (Gelay et al.);
U.S. patent application Ser. No. 29/459,620 for an Electronic Device Enclosure, filed Jul. 2, 2013 (London et al.);
U.S. patent application Ser. No. 29/459,681 for an Electronic Device Enclosure, filed Jul. 2, 2013 (Chaney et al.);
U.S. patent application Ser. No. 13/933,415 for an Electronic Device Case, filed Jul. 2, 2013 (London et al.);
U.S. patent application Ser. No. 29/459,785 for a Scanner and Charging Base, filed Jul. 3, 2013 (Fitch et al.);
U.S. patent application Ser. No. 29/459,823 for a Scanner, filed Jul. 3, 2013 (Zhou et al.);
U.S. patent application Ser. No. 13/947,296 for a System and Method for Selectively Reading Code Symbols, filed Jul. 22, 2013 (Rueblinger et al.);
U.S. patent application Ser. No. 13/950,544 for a Code Symbol Reading System Having Adjustable Object Detection, filed Jul. 25, 2013 (Jiang);
U.S. patent application Ser. No. 13/961,408 for a Method for Manufacturing Laser Scanners, filed Aug. 7, 2013 (Saber et al.);
U.S. patent application Ser. No. 14/018,729 for a Method for Operating a Laser Scanner, filed Sep. 5, 2013 (Feng et al.);
U.S. patent application Ser. No. 14/019,616 for a Device Having Light Source to Reduce Surface Pathogens, filed Sep. 6, 2013 (Todeschini);
U.S. patent application Ser. No. 14/023,762 for a Handheld Indicia Reader Having Locking Endcap, filed Sep. 11, 2013 (Gannon);
U.S. patent application Ser. No. 14/035,474 for Augmented-Reality Signature Capture, filed Sep. 24, 2013 (Todeschini);
U.S. patent application Ser. No. 29/468,118 for an Electronic Device Case, filed Sep. 26, 2013 (Oberpriller et al.);
U.S. patent application Ser. No. 14/055,234 for Dimensioning System, filed Oct. 16, 2013 (Fletcher);
U.S. patent application Ser. No. 14/053,314 for Indicia Reader, filed Oct. 14, 2013 (Huck);
U.S. patent application Ser. No. 14/065,768 for Hybrid System and Method for Reading Indicia, filed Oct. 29, 2013 (Meier et al.);
U.S. patent application Ser. No. 14/074,746 for Self-Checkout Shopping System, filed Nov. 8, 2013 (Hejl et al.);
U.S. patent application Ser. No. 14/074,787 for Method and System for Configuring Mobile Devices via NFC Technology, filed Nov. 8, 2013 (Smith et al.);
U.S. patent application Ser. No. 14/087,190 for Optimal Range Indicators for Bar Code Validation, filed Nov. 22, 2013 (Hejl);
U.S. patent application Ser. No. 14/094,087 for Method and System for Communicating Information in an Digital Signal, filed Dec. 2, 2013 (Peake et al.);
U.S. patent application Ser. No. 14/101,965 for High Dynamic-Range Indicia Reading System, filed Dec. 10, 2013 (Xian);
U.S. patent application Ser. No. 14/150,393 for Indicia-reader Having Unitary Construction Scanner, filed Jan. 8, 2014 (Colavito et al.);
U.S. patent application Ser. No. 14/154,207 for Laser Barcode Scanner, filed Jan. 14, 2014 (Hou et al.);
U.S. patent application Ser. No. 14/165,980 for System and Method for Measuring Irregular Objects with a Single Camera filed Jan. 28, 2014 (Li et al.);
U.S. patent application Ser. No. 14/166,103 for Indicia Reading Terminal Including Optical Filter filed Jan. 28, 2014 (Lu et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 14/250,923 for Reading Apparatus Having Partial Frame Operating Mode filed Apr. 11, 2014, (Deng et al.);
U.S. patent application Ser. No. 14/257,174 for Imaging Terminal Having Data Compression filed Apr. 21, 2014, (Barber et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/274,858 for Mobile Printer with Optional Battery Accessory filed May 12, 2014 (Marty et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/300,276 for METHOD AND SYSTEM FOR CONSIDERING INFORMATION ABOUT AN EXPECTED RESPONSE WHEN PERFORMING SPEECH RECOGNITION, filed Jun. 10, 2014 (Braho et al.);
U.S. patent application Ser. No. 14/305,153 for INDICIA READING SYSTEM EMPLOYING DIGITAL GAIN CONTROL filed Jun. 16, 2014 (Xian et al.);
U.S. patent application Ser. No. 14/310,226 for AUTOFOCUSING OPTICAL IMAGING DEVICE filed Jun. 20, 2014 (Koziol et al.);
U.S. patent application Ser. No. 14/327,722 for CUSTOMER FACING IMAGING SYSTEMS AND METHODS FOR OBTAINING IMAGES filed Jul. 10, 2014 (Oberpriller et al,);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/329,303 for CELL PHONE READING MODE USING IMAGE TIMER filed Jul. 11, 2014 (Coyle);
U.S. patent application Ser. No. 14/333,588 for SYMBOL READING SYSTEM WITH INTEGRATED SCALE BASE filed Jul. 17, 2014 (Barten);
U.S. patent application Ser. No. 14/334,934 for a SYSTEM AND METHOD FOR INDICIA VERIFICATION, filed Jul. 18, 2014 (Hejl);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/340,716 for an OPTICAL IMAGER AND METHOD FOR CORRELATING A MEDICATION PACKAGE WITH A PATIENT, filed Jul. 25, 2014 (Ellis);
U.S. patent application Ser. No. 14/342,544 for Imaging Based Barcode Scanner Engine with Multiple Elements Supported on a Common Printed Circuit Board filed Mar. 4, 2014 (Liu et al.);
U.S. patent application Ser. No. 14/345,735 for Optical Indicia Reading Terminal with Combined Illumination filed Mar. 19, 2014 (Ouyang);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/355,613 for Optical Indicia Reading Terminal with Color Image Sensor filed May 1, 2014 (Lu et al.);
U.S. patent application Ser. No. 14/370,237 for WEB-BASED SCAN-TASK ENABLED SYSTEM AND METHOD OF AND APPARATUS FOR DEVELOPING AND DEPLOYING THE SAME ON A CLIENT-SERVER NETWORK filed Jul. 2, 2014 (Chen et al.);
U.S. patent application Ser. No. 14/370,267 for INDUSTRIAL DESIGN FOR CONSUMER DEVICE BASED SCANNING AND MOBILITY, filed Jul. 2, 2014 (Ma et al.);
U.S. patent application Ser. No. 14/376,472, for an ENCODED INFORMATION READING TERMINAL INCLUDING HTTP SERVER, filed Aug. 4, 2014 (Lu);
U.S. patent application Ser. No. 14/379,057 for METHOD OF USING CAMERA SENSOR INTERFACE TO TRANSFER MULTIPLE CHANNELS OF SCAN DATA USING AN IMAGE FORMAT filed Aug. 15, 2014 (Wang et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/460,387 for APPARATUS FOR DISPLAYING BAR CODES FROM LIGHT EMITTING DISPLAY SURFACES filed Aug. 15, 2014 (Van Horn et al.);
U.S. patent application Ser. No. 14/460,829 for ENCODED INFORMATION READING TERMINAL WITH WIRELESS PATH SELECTON CAPABILITY, filed Aug. 15, 2014 (Wang et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/446,387 for INDICIA READING TERMINAL PROCESSING PLURALITY OF FRAMES OF IMAGE DATA RESPONSIVELY TO TRIGGER SIGNAL ACTIVATION filed Jul. 30, 2014 (Wang et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 29/486,759 for an Imaging Terminal, filed Apr. 2, 2014 (Oberpriller et al.);
U.S. patent application Ser. No. 29/492,903 for an INDICIA SCANNER, filed Jun. 4, 2014 (Zhou et al.); and
U.S. patent application Ser. No. 29/494,725 for an IN-COUNTER BARCODE SCANNER, filed Jun. 24, 2014 (Oberpriller et al.).

What is claimed is:

1. A method for presenting information related to a position within a given delivery vehicle designated for transport of a particular cargo item therein, the method comprising the steps of:
evaluating a cargo, wherein the cargo comprises a plurality of parcels designated for loading into the given delivery vehicle, wherein the particular cargo item comprises a parcel of the plurality of parcels, and wherein the evaluating relates to at least one characteristic of each of the plurality of parcels and a capacity associated with the delivery vehicle;
computing the information related to the position of the particular cargo item within the given delivery vehicle based on the evaluating the cargo step;
registering an entry of the particular cargo item into the given delivery vehicle upon a loading, at least in part, of the cargo therein; and
upon the registering step, and based on the computing the information step, directing a visible identifier to the position designated for transport of the particular cargo item.

2. The method as described in claim 1, wherein the directing the visible identifier step comprises controllably pointing a light beam to the position designated for transport of the particular cargo item.

3. The method as described in claim 2, wherein the controllably pointing a light beam onto a reflective surface on or proximate to the position designated for transport of the particular cargo item.

4. The method as described in claim 1, wherein the registering the entry of the particular cargo item into the given delivery vehicle upon the at least partial loading of the cargo comprises scanning a 2D barcode pattern affixed to the particular cargo item upon the entry thereof into the given delivery vehicle.

5. The method as described in claim 1, further comprising the steps of:
tracking a change in a geographic position corresponding to a location of the delivery vehicle in relation to a route over which the delivery vehicle travels;
detecting, based on the tracking step, one or more of an arrival or an approach of the delivery vehicle location in relation to a geographic position corresponding to a destination address designated for delivery of the particular cargo item; and
redirecting the visible identifier to the position designated for transport of the particular cargo item based on the detecting the arrival or the approach step.

6. The method as described in claim 5, wherein the redirecting the visible identifier step comprises controllably pointing the light beam to at least one of the particular cargo item or the position designated for transport thereof.

7. The method as described in claim 6, wherein the redirecting the visible identifier step further comprises controllably projecting data visibly, the data relating to the delivery of the particular item a light beam to the position designated for transport of the particular cargo item.

8. The method as described in claim 6, wherein the redirecting the visible identifier step comprises one or more of the controllably pointing the light beam or projecting the data related to the delivery of the particular cargo item onto a reflective surface affixed thereon or proximate thereto.

9. The method as described in claim 1, further comprising the step of registering the delivery of the item upon a removal of the particular cargo item from within the given delivery vehicle.

10. The method as described in claim 9, wherein the registering the delivery of the particular cargo item step comprises scanning a 2D barcode pattern affixed to the particular cargo item upon the removal thereof from the given delivery vehicle.

11. The method as described in claim 1, wherein the evaluating the cargo step comprises accessing information related to the at least one characteristic of each of the plurality of parcels and the capacity associated with the delivery vehicle.

12. The method as described in claim 11, wherein the information related to the at least one characteristic of each of the plurality of parcels and the capacity associated with the delivery vehicle comprises data, which is stored in a database.

13. The method as described in claim 1, wherein the delivery vehicle comprises a truck.

14. The method as described in claim 1, wherein the delivery vehicle comprises a transportation mode operable over at least one of a land, air or water based transport medium.

15. A system operable for presenting information related to a position within a given delivery vehicle designated for transport of a particular cargo item therein, the system comprising:
a database component operable for storing information related to a cargo assigned to the delivery vehicle for loading therein and delivery therewith, the information related to at least one characteristic of each of a plurality of parcels of the assigned cargo, wherein the particular cargo item comprises a parcel of the plurality of parcels, and related to a capacity associated with the delivery vehicle;
a scanner component operable for registering an entry of the particular cargo item into the given delivery vehicle upon a loading, at least in part, of the cargo therein;
a computer component communicatively coupled with the database component and operable for:
accessing the information stored in relation to at least one characteristic of each of a plurality of parcels and a capacity associated with the delivery vehicle;
evaluating the cargo based on the accessed information;
computing logistically and, at least in relation to the particular cargo item, a position for transporting the particular cargo item within the given delivery vehicle based on the evaluation of the cargo; and
directing a presentation of the information related to a designation, based on the logistical computation, of the position for transport of the particular cargo item within the given delivery vehicle; and
a pointer component directed by the computer and operable therewith for presenting the information related to the designation of the position for transport of the particular cargo item within the given delivery vehicle.

16. The system as described in claim 15, further comprising:
a geo-positioning component communicatively coupled with the computer component and operable for monitoring a geo-location of the delivery vehicle in relation to a route over which the delivery vehicle travels; and
wherein the computer component is further operable for:
tracking a change in a geographic position corresponding to a location of the delivery vehicle in relation to a route over which the delivery vehicle travels based on the monitored geo-location of the delivery vehicle;
detecting, based on the tracked geo-position change, one or more of an arrival or an approach of the delivery vehicle location in relation to a geographic position corresponding to a destination address designated for delivery of the particular cargo item; and
redirecting the pointer component to point a visible identifier to the position designated for transport of the particular cargo item based on the detection of the arrival or the approach of the delivery vehicle location in relation to a geographic position corresponding to a destination address designated for delivery of the particular cargo item.

17. The system as described in claim 16, wherein the pointer component is further operable for projecting information related to the delivery of the particular cargo item, and wherein the computer component is further operable for controlling the pointer component for the projection of the information related to the delivery of the particular cargo item.

18. The system as described in claim 17, wherein one or more of the information related to the designation of the position for transport of the particular cargo item within the given delivery vehicle or the delivery related information is projected by the pointer component onto a reflective surface on or proximate to the position designated for transport of the particular cargo item.

19. The system as described in claim 15, wherein the scanner component is further operable for:
registering an delivery of the particular cargo item upon a removal thereof from the given delivery vehicle; and
updating one or more of computer component or the database component in relation to the registered delivery of the particular cargo item.

20. A non-transitory computer readable storage medium comprising instructions, the instructions operable for causing or programming a computer processor to perform a method for presenting information related to a position within a given delivery vehicle designated for transport of a particular cargo item therein, the method comprising the steps of:
evaluating a cargo, wherein the cargo comprises a plurality of parcels designated for loading into the given delivery vehicle, wherein the particular cargo item comprises a parcel of the plurality of parcels, and wherein the evaluating relates to at least one characteristic of each of the plurality of parcels and a capacity associated with the delivery vehicle;
computing the information related to the position of the particular cargo item within the given delivery vehicle based on the evaluating the cargo step;
registering an entry of the particular cargo item into the given delivery vehicle upon a loading, at least in part, of the cargo therein;
upon the registering step, and based on the computing the information step, directing a visible identifier to the position designated for transport of the particular cargo item;
tracking a change in a geographic position corresponding to a location of the delivery vehicle in relation to a route over which the delivery vehicle travels;
detecting, based on the tracking step, one or more of an arrival or an approach of the delivery vehicle location in relation to a geographic position corresponding to a destination address designated for delivery of the particular cargo item; and
redirecting the visible identifier to the position designated for transport of the particular cargo item based on the detecting the arrival or the approach step.
